(19) United States
(12) Patent Application Publication
(10) Pub. No.: US 2025/0225665 A1
(43) Pub. Date: Jul. 10, 2025

(54) Event-Based Aerial Detection Vision System

(71) Applicant: Noam Kenig, Vancouver (CA)

(72) Inventor: Noam Kenig, Vancouver (CA)

(21) Appl. No.: 17/533,729

(22) Filed: Nov. 23, 2021

Related U.S. Application Data
(60) Provisional application No. 63/118,390, filed on Nov. 25, 2020.

(51) Int. Cl. G06T 7/292; G06V 20/40; G06V 20/58; H04N 23/695

(52) U.S. Cl. CPC G06T 7/292; G06V 20/44; G06V 20/58; H04N 23/695

(57) ABSTRACT

The invention is a system capable of detecting, classifying, tracking, and calculating an aerial objects' trajectory by using event-based sensor cameras. By implementing AI and/or Machine Vision algorithms, the system can distinguish between different aerial objects in extremely high accuracy and verse environmental conditions. The system can also calculate the trajectory of the aerial object in real-time.

### Field of the Invention

The invention relates to image processing to detect aerial objects, in particular using event-based cameras to detect birds, aerial vehicles and projectiles.

### BACKGROUND

Classical image processing is based on the evaluation of data delivered by an image sensor system in the form of frames. Conventional, clocked image sensors acquire the visual information from the scene either sequentially for each pixel or each pixel line/column or, in various patterns, pixel parallel, but always time-quantized at some frame rate. Each frame of data recorded, transmitted, and needs to be post-processed in some fashion carries the information from all pixels, regardless of whether this information has changed since the last frame had been acquired.

This makes standard frame-based cameras of limited ability for detecting objects in real-time. The current standard frame-based camera aerial objects detection systems suffer from a technological limitation of detecting fast, small, and far aerial objects due to difficulties in detecting the aerial object visual features when using a frame-based regular or thermal camera. For example, a hovering drone is hard to detect and classify correctly using a frame-based camera, especially when it's in front of a complex background (trees, clouds, birds, low visibility, etc.). Radar also has difficulties in detecting slow-moving objects, especially hovering objects. Even if an object can be detected by either radar or frame-based cameras, their algorithms struggle to classify it.

Some fundamental vision-based aerial object detection system challenges include detecting, tracking, and recognizing the aerial object's visual features. Despite the advances in computational power, pixel resolution, and frame rates, even state-of-the-art imaging technologies fall short of the robustness, reliability, and low energy consumption of event-based vision systems. The inventor has appreciated the advantage of using an event-based camera to solve this.

### SUMMARY OF THE INVENTION

According to one aspect of the invention there is provided a method of detecting aerial objects comprising: capturing event images of a scene using an event-based camera; detecting events within the event-images; computing properties of the detected events to detect candidate aerial objects and compute their physical properties.

The event-data may comprise pixel coordinates, timestamp, and polarity of change.

The computed physical properties of candidate aerial objects may be one or more of: speed, size, shape, propeller rotation, spin, and frequency.

The event-based camera may be located on an unmanned aerial vehicle (UAV).

The method may comprise computing a trajectory of the detected candidate objects from a plurality of detected events

The method may comprise extrapolating an estimated origin of the object from the computed trajectory or may comprise extrapolating an estimated target or future location of the object from the computed trajectory.

The method may comprise identifying an aerial object classification of the candidate aerial object(s) from the computed properties of the detected events and/or candidate aerial objects.

The method may comprise setting the field of view for the event-based camera using a frame-based camera.

According to another aspect of the invention there is provided an aerial detection system comprising: an event-based camera for capturing event images of a scene; a processor for detecting events within the event-images and computing properties of the detected events to detect candidate aerial objects and compute their physical properties.

The aerial detection system may comprise an unmanned aerial vehicle (UAV) or missile homing head for housing the event-based camera and processor.

The aerial detection system may comprise a frame-based camera to set the field of view for the event-based camera.

The aerial detection system may comprise means to pan, tilt, and zoom the event-based camera.

The aerial detection system may comprise at least one further event-based cameras arranged in a stereo, panoramic or spherical capture arrangement.

The aerial detection system may comprise ranging means to detect a distance of the detected object from the event-based camera.

The aerial detection system may comprise illumination means.

### BRIEF DESCRIPTION OF THE DRAWINGS

Preferred embodiments of the invention may be described with reference to the drawings, in which:

FIG. 1A is an overall schematic illustration of the difference between the frame-based camera and event-based camera;

FIG. 1B is an overall schematic illustration of a hybrid sensor-based event-based camera with a full frame-based image camera;

FIG. 2 is an illustration of the view from an event-based camera of an aerial object;

FIG. 3 is an illustration of the use of the ground event-based camera to detect an aerial object;

FIG. 4 is an illustration of the use of an airborne event-based camera to detect an aerial object;

FIG. 5 is an illustration of the use of a vehicle-mounted platform event-based camera to detect an aerial object;

FIG. 6A is an illustration of the use of an airborne event-based camera on an interceptor drone;

FIG. 6B is an illustration of the use of an airborne event-based camera on an missile;

FIG. 7 is an illustration of the use of an event-based camera to calculate the trajectory of aerial objects (rocket, missiles, mortars);

FIG. 8 is an illustration of the use of an event-based camera to calculate the trajectory of bullets;

FIG. 9 is an illustration of the use of an event-based camera together with IR illumination;

FIG. 10A is an illustration of the use of stereo event-based cameras to calculate distance and trajectory;

FIG. 10B is an illustration of the use of a number of event-based cameras;

FIG. 11 is an illustration of the use of an event-based camera on a pan tilt zoom gimbal;

FIG. 12 is an illustration of the use of multiple event-based cameras configuration;

FIG. 13 is an illustration using a laser rangefinder combined with the event-based camera to estimate a selected aerial object's range;

FIG. 14 is an illustration of the use of a laser to mark an object in the event-based camera footage;

FIG. 15 is an illustration of the use of the event-based camera on an aerial platform for the benefit of sense and avoid;

FIG. 16 is an illustration of the use of the event-based camera in airports to protect from birds and drones or any other aerial object;

FIG. 17 is a software logic flowchart for generating temporal profile and frequency of pixels from event data;

FIG. 18 is an illustration of components of a 3D tensor;

FIG. 19 is a 3D tensor data having temporal profile and frequency for DNN inference;

FIG. 20 is a top view comparison of a single versus triple camera system; and

FIG. 21 is a data block diagram for combining data sources.

### DETAILED DESCRIPTION

The present disclosure is directed generally to systems and methods for detecting, classifying, tracking, and calculating an aerial object's trajectory by the use of event-based sensor cameras. The aerial objects may be aerial vehicles or projectiles such as drones, balloons, birds, artillery, rockets, mortars, missiles and bullets. By analyzing the captured object frequencies, shape, size and behavior, the camera can distinguish between objects even with only a few captured pixels.

An event-based camera, also known as a neuromorphic camera, silicon retina or dynamic vision sensor, is an imaging sensor that responds to local changes in brightness. Event cameras do not capture images using a shutter as conventional cameras do. Instead, each pixel inside an event camera operates independently and asynchronously, reporting brightness changes as they occur and staying silent otherwise. Modern event cameras have microsecond temporal resolution, high dynamic range, and less under/overexposure and motion blur than frame cameras.

Event-based cameras offer significant advantages over standard cameras, namely a very high dynamic range, no motion blur, and a latency in the order of microseconds. However, because the output is composed of a sequence of asynchronous events rather than actual intensity images, traditional vision algorithms cannot be applied.

In the case of a hovering drone, the event-based camera can detect the frequency of the vibrations that coming from the propellers from far away object even without seeing the complete shape and can use this information as a better way to classify the object. Unlike a frame-based camera the present system just needs a few pixels to classify the object correctly.

The event-based vision camera system works radically different from traditional frame-based cameras. It senses the changes in a dynamic scene rather than on a fixed Frame Per Second that has no relation to the viewed scene. It is designed on hardware at the pixel level to detect change in brightness, which are called events. These events are output as event data. The system uses the event data to detect, track, and recognize moving objects. The system may classify the object and calculate its flying trajectory using event-based image processing and AI algorithms.

Inspired by the biological vision system, an event-based neuromorphic vision system uses a specially designed and customized asynchronous imaging sensor that replicates biological retinas benefits, especially when tracking fast-moving objects. Some new hybrid events-cameras combine the capability in the sensor level to work as an event-based camera in the visible light, and the Near-IR or the IR spectrum and stimulatingly or consecutively generate a complete image that can be in the visible light or the Infra-Red spectrum and by doing that add to another layer of data that can be used for detection and classification of the aerial object

A representative system is composed of an event-based camera system using an asynchronous sensor that senses the changes in a dynamic aerial scene rather than on a fixed Frame Per Second that has no relation to the viewed scene, the event-based camera advantages such as its low latency (in the order of microseconds), extremely high dynamic range (above 140 dB vs. 60 dB of standard cameras), low power consumption (below 10 mW), and the ability to detect a fast-moving object using an exceptionally high refresh rate (above 10,000 fps). Combined with event-based AI and/or Machine Vision algorithms, the system can detect and classify aerial objects, as well as project and track their flight trajectory. Some advantages of event-camera systems include less computing power requirements to process Machine Vision (MV) and AI applications (10× to 1000× less data compared to FPS camera).

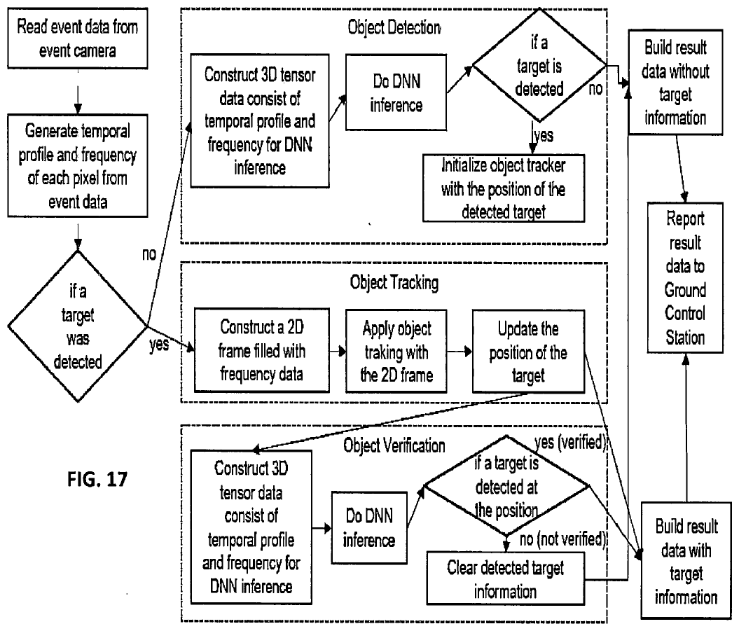

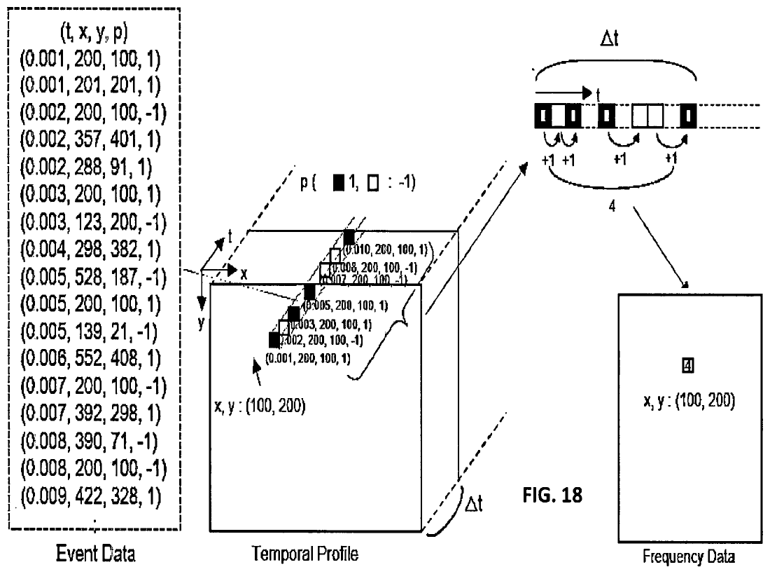

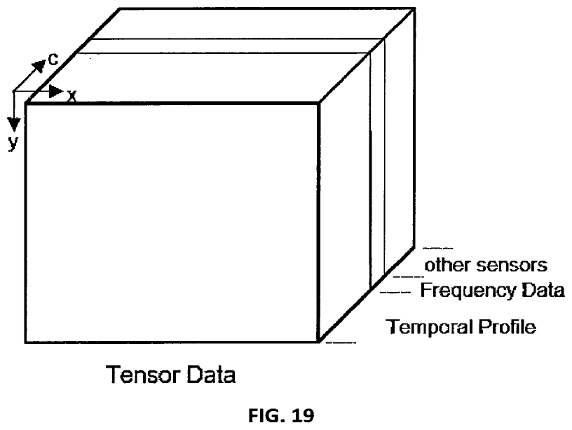

FIG. 17 is a flowchart for data processing of event data for Object Detection, Object Tracking, and Object Verification. FIG. 18 provides details for generating temporal profiles and FIG. 19 provides details for constructing a 3D tensor.

FIG. 18 illustrates the generation of a temporal profile and frequency of pixels from event data. Event data is a 4-tuple (t, x, y, p) where t is timestamp, (x,y) are spatial coordinates of pixel, and p is polarity (sign of the brightness change). In the given period Δt, event data for each pixel are mapped to the corresponding coordinates in the Temporal Profile to form 3D data (x, y, t). During Temporal Profile building, the change of p values on each pixel is also calculated and the count is stored as Frequency Data. The frequency of the pixel is calculated by checking the change of p values in given period Δt.

FIG. 19 shows a 3D tensor data having temporal profile, frequency data and optional additional sensor data for the DNN inference. The Tensor Data is constructed by adding Frequency data to the Temporal Profile to form a 3D data set of axes x, y, c where c is the channel of tensor data. The count of the channel is variable depending on the size of the Temporal Profile which is built in the given period Δt. Additional sensor data may be added, for example conventional cameras, which may capture gray-scale (x, y, 1) or RGB color (x, y, 3) frames.

Advantageously, the faster the object to be detected moves or vibrates, the better the detection success rate is, including an increased detection range. Even hovering or slow-moving drones can be detected and identified. Event-based aerial detection systems can operate in broad environmental and lighting conditions, including rainy weather.

The system is not only capable of detecting drones or balloons, but it also possesses the capabilities to identify, track and calculate ballistic, fast-moving objects and even locate their starting point, such as the source of a fired bullet. To identify and track, the system generates the trace of a target from event data and uses it as a classification by analysing the property of the trace. For instance, a shooting bullet generates a linear trace and a ballistic missile makes a parabola trace. For each of multiple event cameras, the system calculates a target direction from its position, which forms multiple direction vectors in 3D geodetic space. The system estimates the starting position by finding the intersection of all direction vectors.

The event-based camera can also detect the discharge during the shooting and detect the shooter's location in the scene. The predicted trajectory may be calculated as discussed herein.

An event-based vision system, also known as neuromorphic vision sensors, inspired by a biological vision, uses an event-driven frameless approach to capture transients in visual scenes. In contrast to conventional cameras, neuromorphic vision sensors only transmit local pixel-level changes (called “events”) caused by movement in a scene at the time of occurrence and provide an information-rich stream of events with a latency within tens of microseconds. To be specific, a single event is a tuple, where x, y are the pixel coordinates of the event in 2D camera space, t is the timestamp of the event, and is the polarity of the event, which is the sign of the brightness change (increasing or decreasing). Furthermore, the requirements for data storage and computational resources are drastically reduced due to the sparse nature of the event stream. Apart from the low latency and high storage efficiency, neuromorphic vision sensors also enjoy a high dynamic range. In combination, these properties of neuromorphic vision sensors inspire an entirely new system of detecting aerial objects.

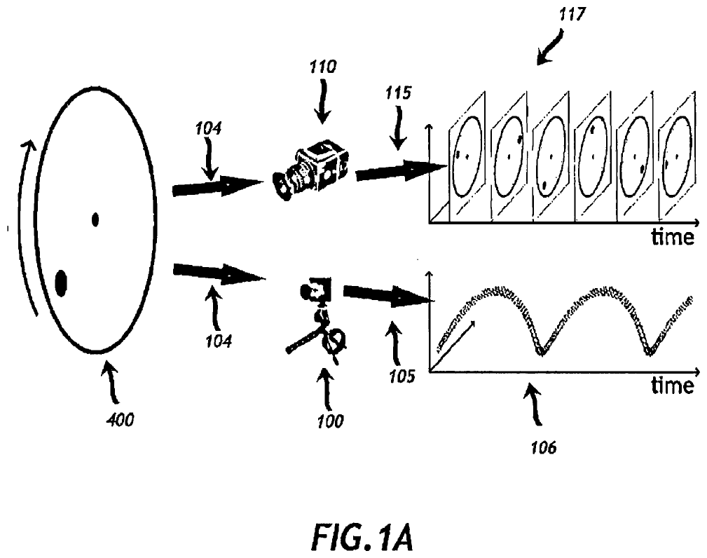

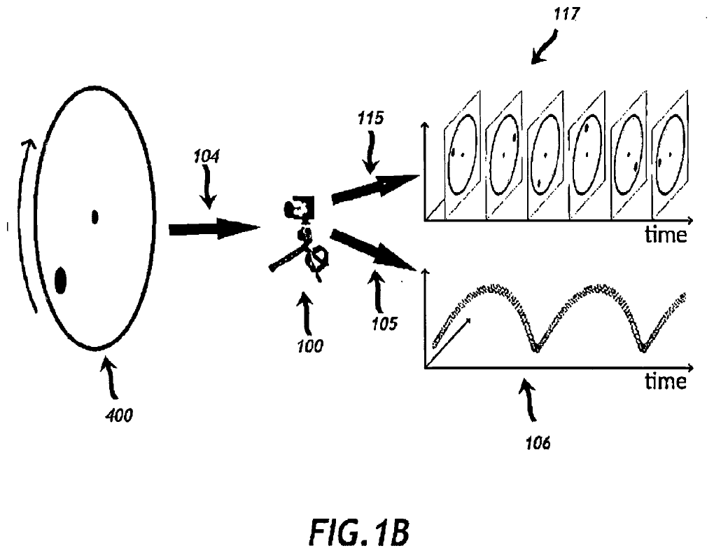

FIG. 1A is an overall schematic illustration of the difference between the frame-based camera 110 and event-based camera 100 to elucidate the mechanism of neuromorphic sensors more clearly, comparing standard frame-based cameras and neuromorphic vision sensors. Visualization of the output from a neuromorphic vision camera 100 output 105 and a standard frame-based camera 110 output 117 when facing a rotating disk with a black dot 400. Compared to a conventional frame-based camera, which transmitted complete images at fixed latency 117, the neuromorphic vision sensor emitted events individually and asynchronously when they occur 106, and therefore output the changes in the captured image (in this case rotating disk 400) at any giving time.

FIG. 1B is an overall schematic illustration of a hybrid sensor-based event-based camera with a full frame-based image camera, and some camera sensors can be switched in the camera sensor firmware level and be used as both an event-based camera and frame-based camera at the hardware level of the sensor.

In the case of the hybrid sensor, visualization of the output from the hybrid camera 100 output an event-based output 105 or full image frame-based output 115 simultaneous or sequential when facing 104 a rotating disk with a black dot 400 and the data output can be output complete images at fixed latency 117, or the emitted events individually and asynchronously when they occur 106 and therefore output the changes in the captured image (in this case rotating disk 400) at any giving time.

The event-based and hybrid-based sensor can also work in the visible and in the IR spectrum as well (for example, SWIR, MWIR, LWIR IR spectrums)

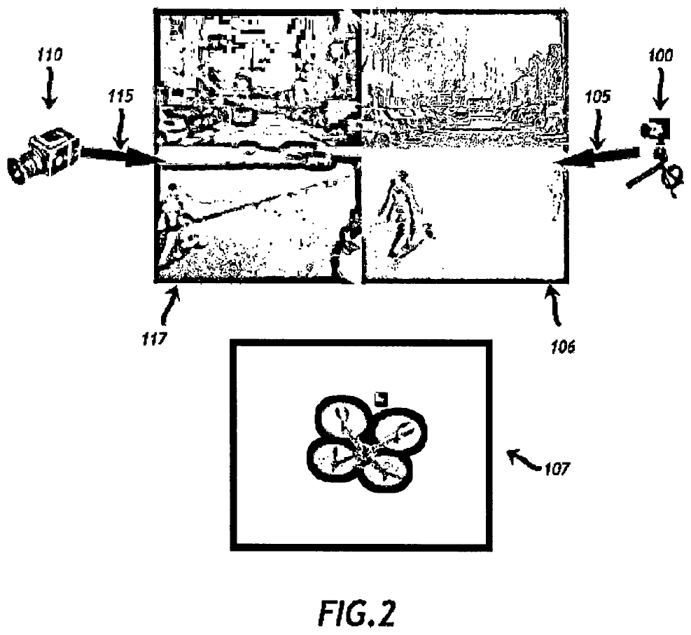

FIG. 2 illustrates the comparison view from regular frame-based camera 110 vs event-based camera 100 while the video output of the frame-based camera 115 shows limited data in low-visibility scenario 117. In contrast, the event-based camera output 105 can distinguish more details view 106 to the events that occur in the scene that trigger event-based camera sensors. By using this extreme event-based data sensor sensitivity, the camera can detect fast-moving objects such as but not limited to a drone and especially the drone propellers as seen in the event-based video output 107, but using that captured information, the detection system AI and Machine vision algorithms can classify the object based on shape, speed, and the frequency of the changes in the scene, such as the frequency of the spinning propellers. The system uses DNN as an object detector. The input to the DNN, tensor data, is constructed from a series of event data, which contains both special and temporal data, which describe the shape, speed and frequency of the object in the given period.

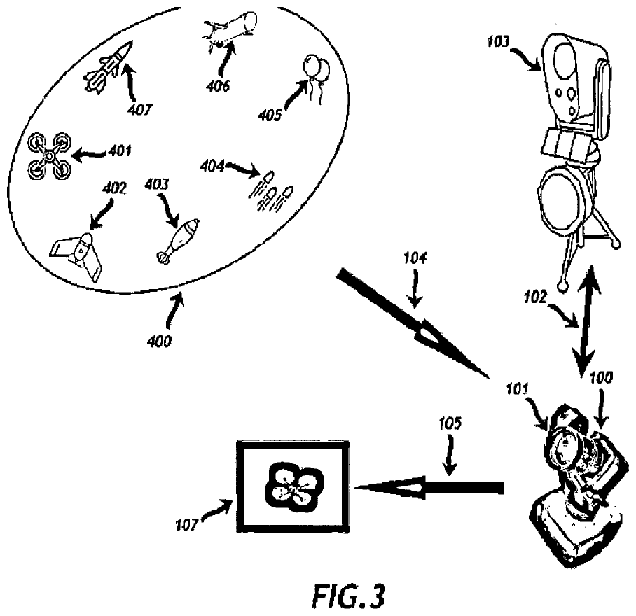

FIG. 3 illustrates the use of the ground configuration of the event-based camera 100 to detect an aerial object 400, such as multi-rotors drones 401, fixed-wing drones 402, mortars 403, bullets 404, balloons 405, cruise missiles 406, and rockets 407. The event-based camera 100 captures the environment or scene 104 with a field of view and range depending on the optical element 101 attached to the camera 100 and outputs event data 105 in real-time. The captured event-based image in exemplified by the multi-rotor image 107. The event-based camera 100 can work as a standalone or integrated with other detections system 103 such as radar or other optical elements that help detect, track, classify, and position the detected aerial object 400. In a standalone version the system can act as: 1) scan an area to detect an intruder; 2) zoom in to a selected area if the intruder is too small; 3) classify the object; 4) track the target object; or 5) verify the target object.

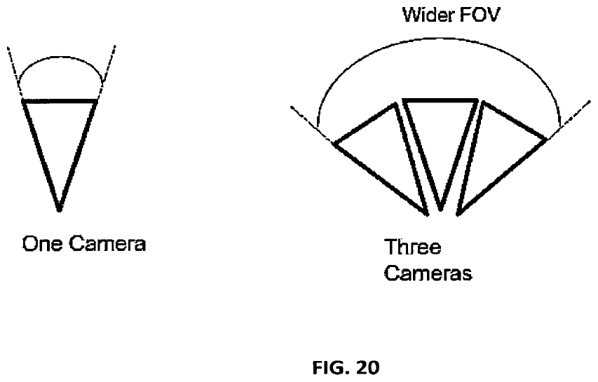

One issue with the standalone version is that the narrow field of view (FOV) when zoomed in may lead the system to miss another intruder out of the FOV but inside the scanning area. By integrating with other detection sensors, the processors can keep monitoring the whole scanning area. Similarly deploying multiple camera, aimed in different directions, the scanning FOV can be increased, as illustrated in FIG. 20.

The sensor systems may cooperate as Scanner and Detector. The Scanner monitors the target area and feeds the information (position or direction) to the Detector when intruders are coarsely sensed. The Detector aims the sensors toward a target area based on the sensed information by changing gimbal pose and camera zoom to see the intruder clearly. The Detector classifies the intruder and tracks it if identified as a target object.

The event-based camera 100 can supplement other detection systems 103 to detect better, track, and classify the detected objects. For example, radar can be used to detect an object and use the event camera to classify it. A similar approach can work with a high-resolution camera in the visible and in the IR spectrum to provide more information on the detected object. The system can also work the other way around when the event-based camera 100 detects an object and use a high megapixel camera to classify it.

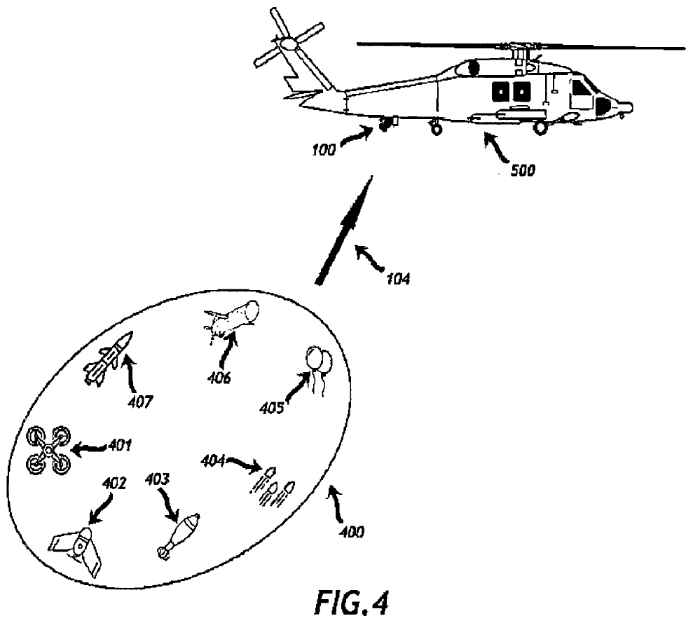

FIG. 4 illustrates the use of the event-based camera 100 on an airborne platform such as but not limited to helicopter 500, so the captured image 104 of the aerial object 400 can be detected. The captured event-image can then be used to deploy countermeasures and inform the crew of nearby objects of aerial threats.

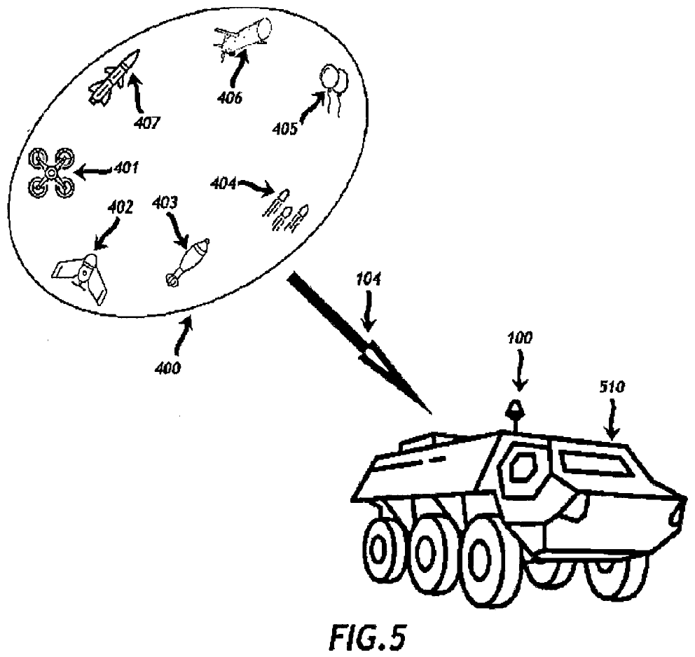

FIG. 5 illustrates the use of the event-based camera 100 on a vehicle-mounted platform such as but not limited to combat, transport, platform 510 on or ground or sea 510, so the captured scene 104 of the aerial object 400 can be detected. The captured event-image can then be used to deploy countermeasures and inform the crew of nearby objects of aerial threats.

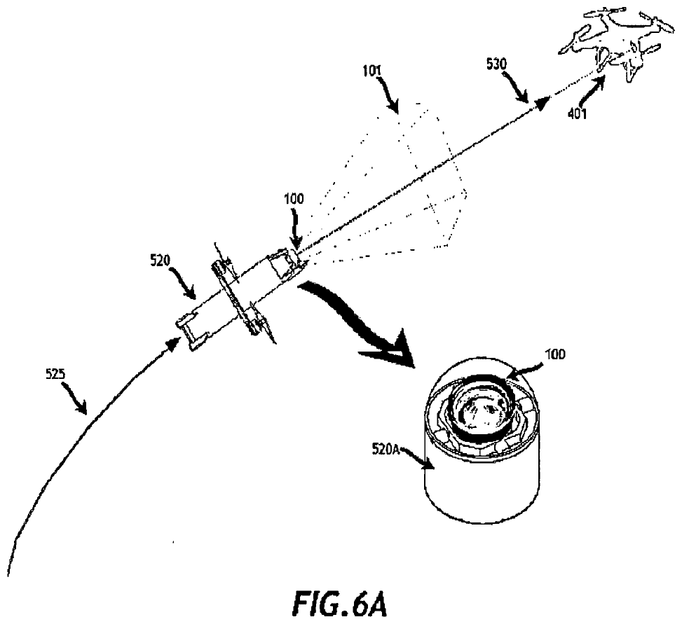

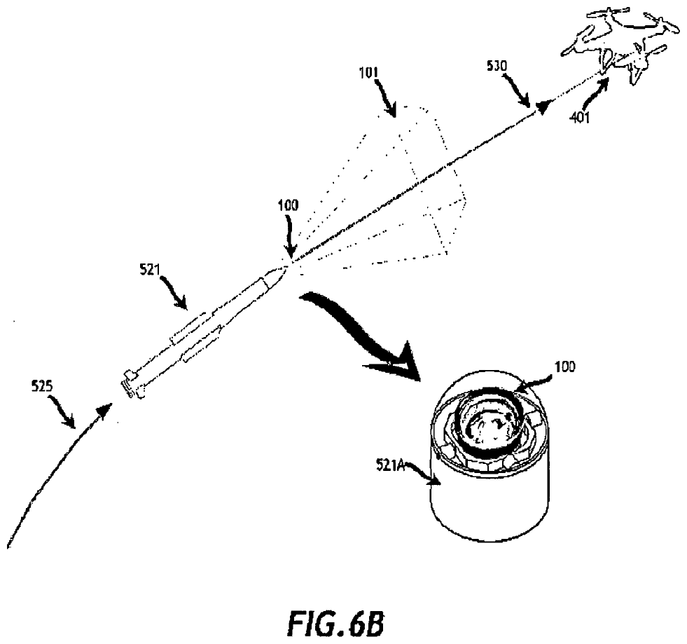

FIG. 6A illustrates the use of an airborne event-based camera 100 on an unmanned aerial vehicle (UAV), such as a drone 520 or missile. While the UAV flies on a course 525 toward its target, such as multi-rotor drone 401, the event-based camera 100 onboard the UAV 520 detect the target 401 in its field of view 101. The event-image is processed in real-time on-board to detect the target and guide the UAV 520 to fly in an intercepting trajectory 530 toward the detected target 401. With the information for target position given, the processor can estimate the position, speed and acceleration of the target by using an EKF system. Depending on the target type (e.g. ballistic or missile) the processor can formulate the trajectory (e.g. parabola) in 3D geodetic coordinates system and estimate the whole trace of the target movement. The processor may provide the flight vector to the UAV interceptor to hit the target at the predicted position and time.

FIG. 6B illustrates the use of an airborne event-based camera 100 on an interceptor 521, such as a missile. While the interceptor flies along path 525 toward its target, such as multi-rotor drone 401, the event-based camera 100 onboard the target by using an EKF system. Depending on interceptor seeker head 521A detects the target type (e.g. ballistic or missile) 401 in its field of view 101 and that information guides the processor can formulate the interceptor 521 to fly in an intercepting trajectory (e.g. parabola) in 3D geodetic coordinates system and estimate the whole trace of the target movement. The processor may provide the flight vector to the UAV interceptor to hit the target at the predicted position and time. The interceptor flies along path 530 toward the detected target 401.

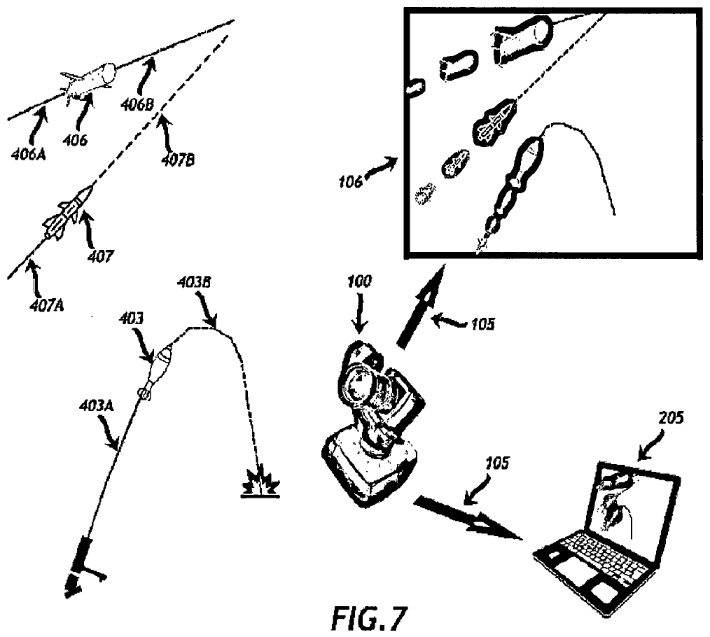

FIG. 7 illustrates the use of an event-based camera 100 calculating aerial objects' trajectory such as but not limited to missile 406, rocket 407, and mortar 403. The event-based camera 100 captures the scene of the moving object and outputs event-data to create image 106. A processing unit such as computer 205 may run algorithms based on the object classification, size, speed, spin and direction to calculate its trajectory, future position, and origin. Based on plural detected positions of the target at known times, the processor computes a prior movement vector and fits a spline, parabola, line or curvilinear equation to define its trajectory. The identification of the object and their physical properties further help define the trajectory, e.g. unpowered objects can be assumed to follow a parabola, while powered objects may be following some pre-programmed, controlled trajectory. For example, missile 406, rocket 407, and mortar 403 movement events can be detected by the event-based camera 100 and based on previous movement vector 406A, 407A and 403A the processor calculates the predicted trajectory 406B, 407B and 403B.

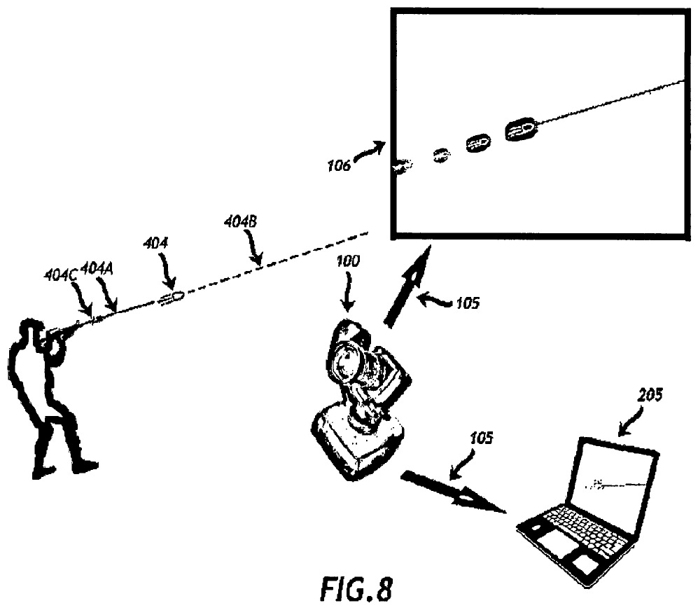

FIG. 8 illustrates the use of an event-based camera 100 calculating an aerial objects' trajectory, such as flying bullets 404, and/or the detection of the fire 404C coming out from the rifle or gun. The event-based camera 100 captures the scene of the moving object and outputs 105 the raw footage 106 to a processing unit such as a computer 205, so the processing unit can run algorithms. Based on the object's classification, size, speed, and direction, the processor can calculate the predicted trajectory and in some cased its origins. For example, a bullet 404 movement event can be detected by the event-based camera 100 and based on previous positioning 404A to calculate the predicted trajectory 404B. The event-based camera 100 can also detect the fire 404C coming out during the shooting and detect the shooter's location in the scene.

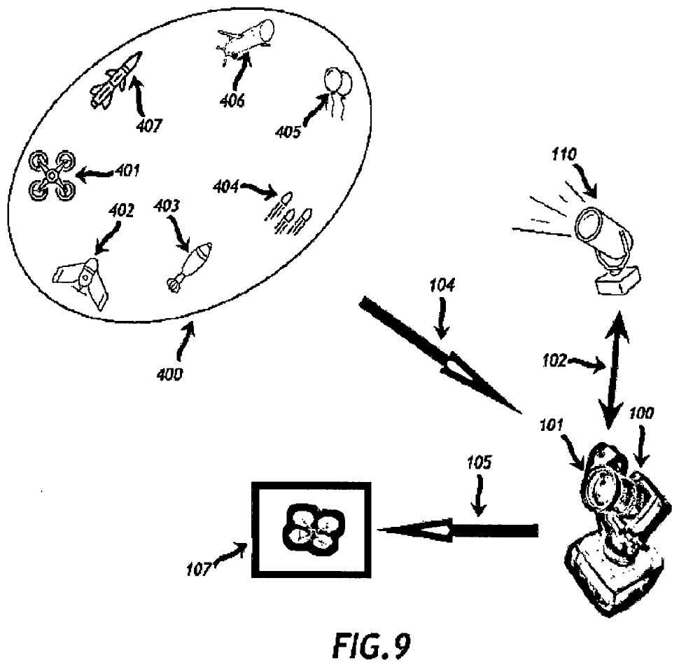

FIG. 9 illustrates the use of the ground configuration of the event-based camera 100 to detect an aerial object 400, such as multi-rotors drones 401, fixed-wing drones 402, mortars 403, bullets 404, balloons 405, cruise missiles 406, and rockets 407. The event-based camera 100 captures the scene 104 with a field of view and range that may be different from and the optical element 101 coupled to control the event-camera 100 and output event-data 105 in real-time, such as in the sample multi-rotor footage 107. The event-based camera 100 can work as a standalone or integrated with illumination device 110, such as visible lighting or IR illumination to help the event-based camera 100 to capture objects at night or with low visibility conditioning. The illumination device 110 can be switched on constantly when needed or flickered or strobed in specific frequencies to help the event-based camera distinguish between object reflections, to use the captured event-image 107 for classification and determine the distance from the event-based camera 100. The processor may use the captured event-image 107 in low light environments for detection, classification and determining the distance from the event-based camera 100 by calculating the time it takes the light to travel and hit the object and return to the camera 100 (similar to laser rangefinder technology) or by checking the detected aerial object size between flashes to determine if it's getting closer or farther from the camera 100.

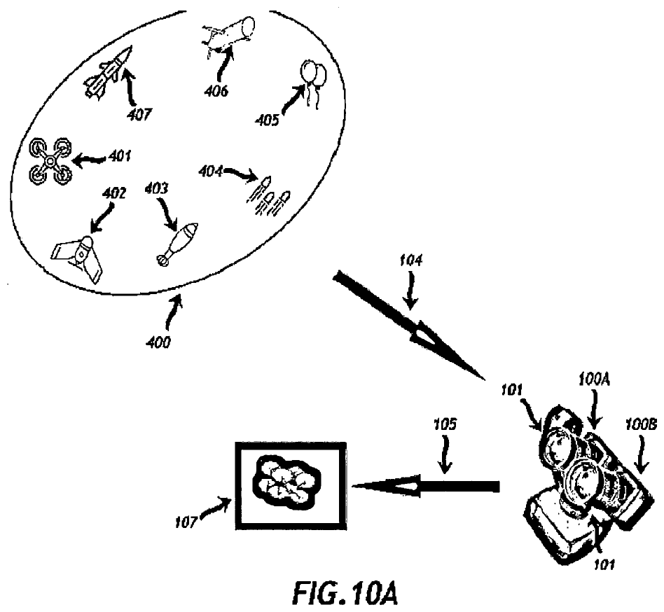

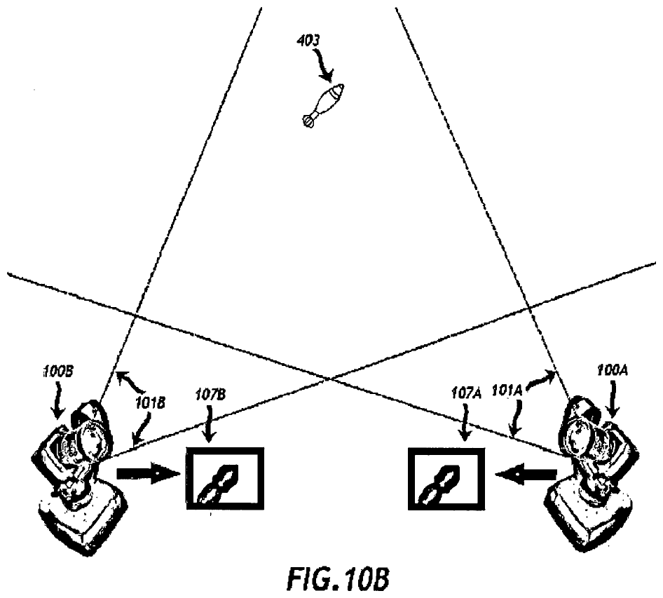

FIG. 10A illustrates the use of plural of an event-based cameras 100A and 100B, in stereo arrangements. By combining multiple event-based cameras with optical element 101 (e.g. lenses) and their video output 105 calibration the processor can determine the offset parallax effect between the captured image 107 of the aerial object 400 to calculate the distance of the objects 400 in 3D space and to estimate a better trajectory and classification. That is, by using two images of the same scene obtained from slightly different angles by both cameras 100A and 100B, it is possible to triangulate the distance to an object with a high degree of accuracy. If the position of camera 101 is known, it is possible to triangulate to know the exact coordinates of the detected object.

FIG. 10B illustrates the use of a number of event-based cameras 100A and 100B deployed in known geolocations and having an overlapping field of views such as 101A and 101B. When both event-based cameras 100A and 100B detect an aerial threat, such as mortar 403, by adding the geolocation of the event-based cameras 100A and 100B and the detected aerial threat vector, a computer algorithm calculates the offsets parallax between the captured footages 107A and 107B of the aerial object 403 to calculate the distance of the objects 403 in 3D space and to have a better trajectory and classification information by combining the footage from all the imaging sources.

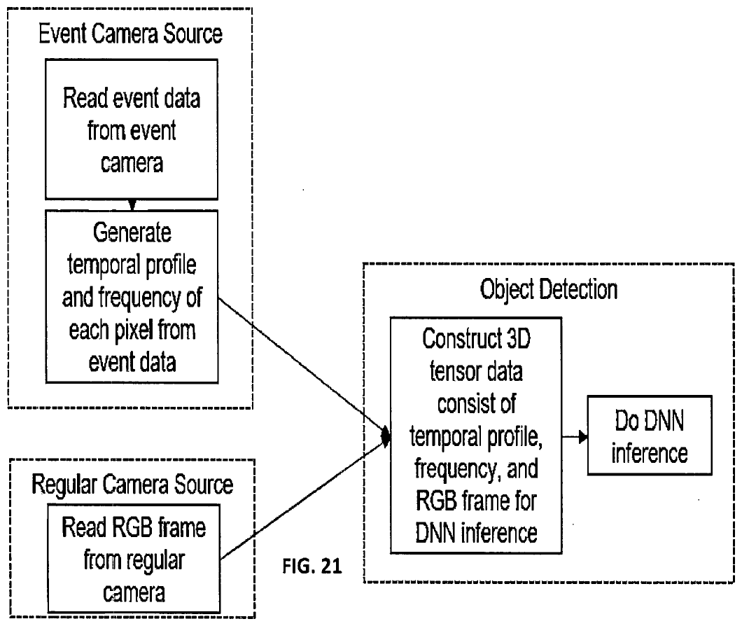

A standard optical camera may also be coupled together with the event-based camera to set the Field of View by jointly panning, zooming, and tilting. That is the event-camera(s) captures what the user can see. Moreover, the events may be overlaid on the standard image to visualize the object moving within the scene to a user. As described in FIG. 19, tensor data for object detection has temporal and frequency data and can be expanded with the data from other sensors. For instance, when a regular color (RGB) camera is added to the configuration, the 3 color channels can be added to the tensor data. FIG. 21 illustrates such a combination of data.

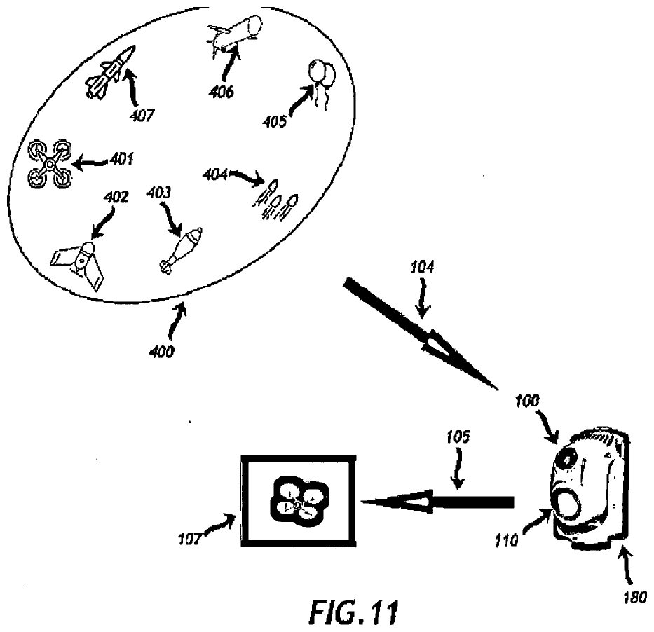

FIG. 11 illustrates the use of an event-based camera 100 having a pan, tilt and zoom gimbal 180 configuration that could be combined with other optics element 110 such as secondary cameras, thermal camera, IR illuminator to scan an area in unison, to better coordinate tracking the detected objects 400 during movement. The processor may use the object's computed trajectory to estimate subsequent positions and thus control the camera system orientation.

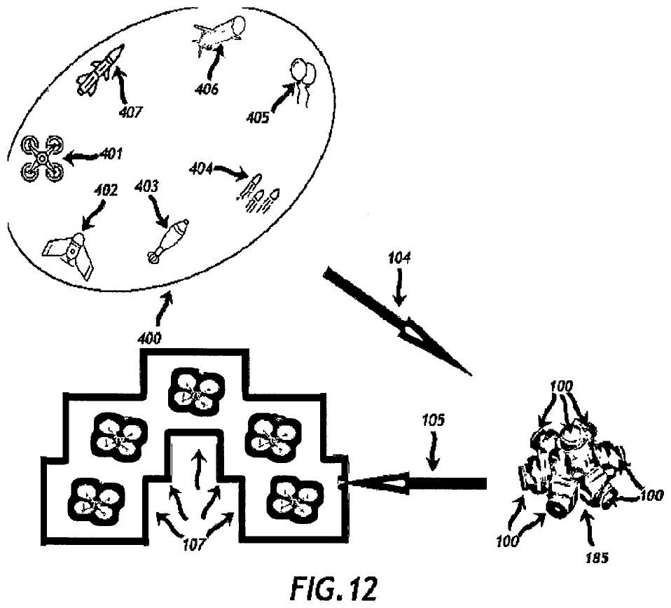

FIG. 12 illustrates the use of multiple event-based cameras 100 in combined configuration 185 that can capture a large field of view by combining the captured footage 104 from different angles and output in real-time 105 the captured footage 107 the event-based cameras at the same time. This may create a panoramic or spherical field of view.

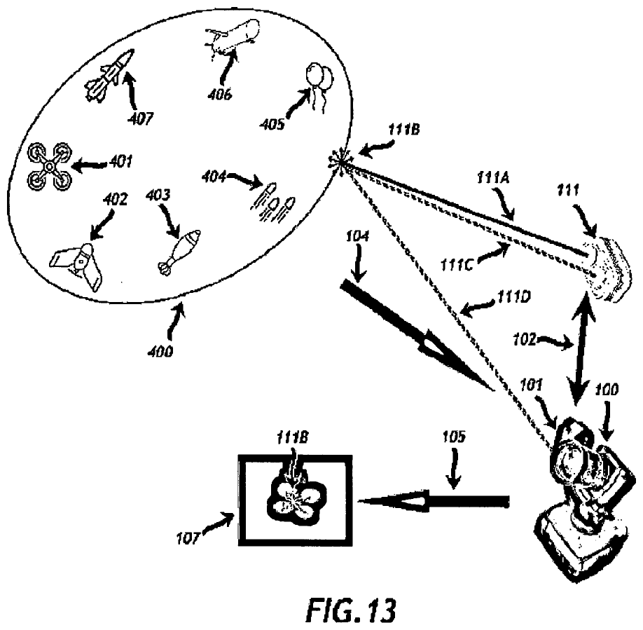

FIG. 13 illustrates using a laser rangefinder combined with the event-based camera 100 to estimate selected aerial object 400 range, such as but not limited to multi-rotors drones 401, fixed-wing drones 402, mortars 403, bullets 404, balloons 405, cruise missiles 406, and rockets 407. While the event-based camera 100 captures the scene 104 with different fields of view and ranges based on the optical element 101 attached, the camera 100 and output 105 in real-time the captured event-based footage such as in the sample multi-rotor footage 107. The event-based camera 100 can work as a standalone or integrated 102 with laser rangefinder device 111, which can help the event-based camera 100 to aim a pulsed laser 111A to specific aerial object and detect the laser reflection 111B, back to the laser rangefinder 111C or 111D to be detected by the event-based camera 100 to calculate the time took to the laser to fire out from the laser diode and back to the source, by using the known light speed and basic calculation the distance to the pointed target can be calculated.

By adding the known camera geolocation position, camera aimed vector, and distance, it is possible to calculate the aerial object's 400 exact positions.

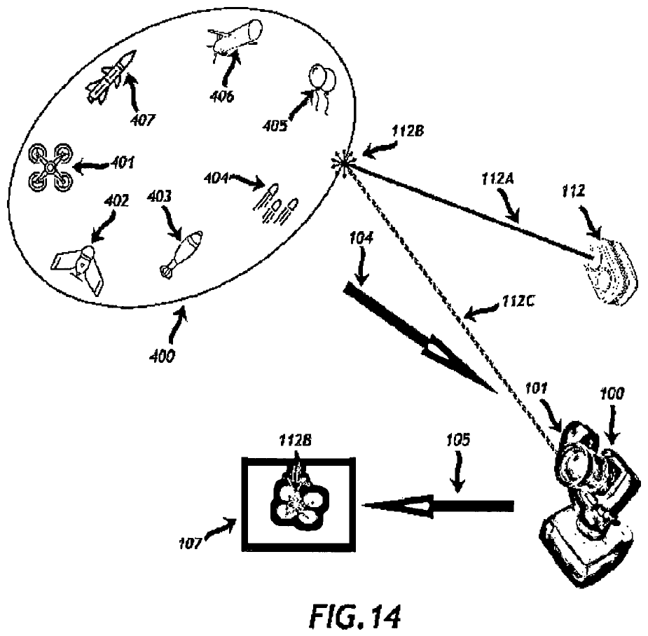

FIG. 14 illustrates the use of laser pointer 112 to mark a target 400 that is visible to the event-based camera's 100 field of view to selected and make a specific aerial object 400, such as but not limited to multi-rotors drones 401, fixed-wing drones 402, mortars 403, bullets 404, balloons 405, cruise missiles 406, and rockets 407. While the event-based camera 100 captures the scene 104 with different fields of view and ranges, based on the optical element 101 attached, the camera 100 outputs in real-time the captured event-based footage, such as in the sample multi-rotor footage 107. The event-based camera 100 can work as a standalone or together with laser pointer device 112, which can be aimed at a selectable target and pulsed laser 112A to specific aerial object and detect the laser reflection 112B, so the event-based camera 100 can detect the reflection back 112C and focus on the selectable target.

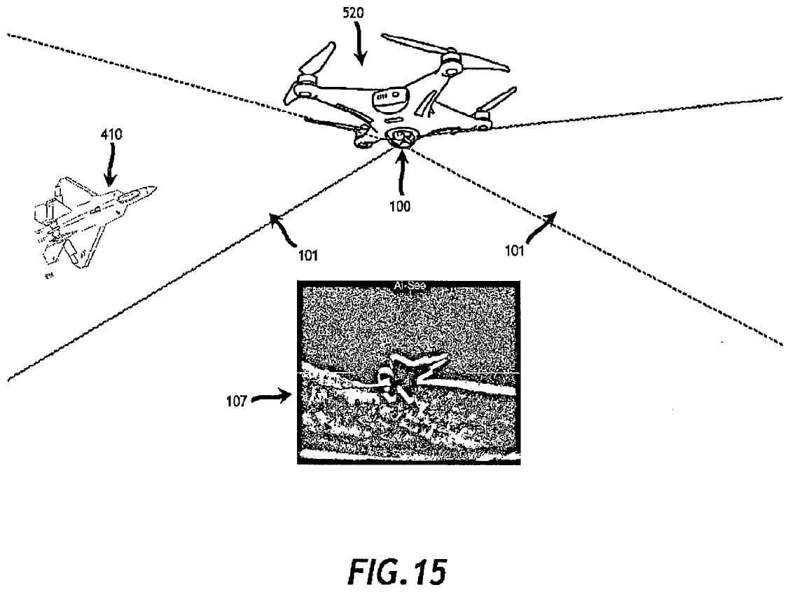

FIG. 15 illustrates the use of the event-based camera 100 on an aerial platform, such as a drone 520 for sensing and avoiding other aerial objects such as airplane 410.

The event-based camera 100 may have a wide-angle view lens, catadioptric panoramic lens, or multiple event-based cameras configuration to cover a large field of view 101 around or directional from the aerial platform 100 to detect incoming or nearby aerial objects.

The captured footage 107 will be automatically processed to move the aerial platform away from the incoming aerial object and/or send a warning to the operator of nearby aerial objects.

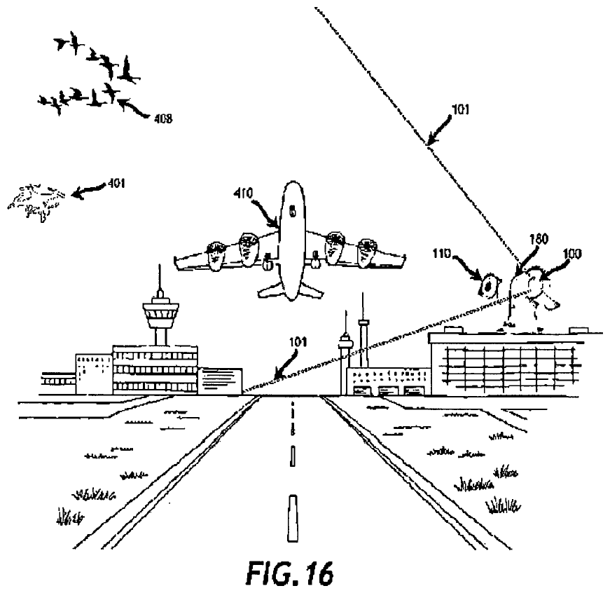

FIG. 16 illustrates the use of an event-based camera 100 in civilian airspace control, such as an airports, to protect from aerial objects that can threaten the safety of manned and unmanned aircraft 410 from aerial threats such as birds 408 and drones 401 or any other aerial object.

The event-based camera 100 that installed inside a pan, tilt, with optional zoom gimbal 180 configuration that could be combined with another optical element 110 such as a secondary camera, thermal, IR illuminator, range finder, secondary event-based camera, or other sensor to scan an area, detect objects, track them, and send warnings to an operator of detected aerial threats that enter the controlled airspace that inside the event-based camera 100 fields of view 101.

FIG. 17 illustrates the software logic flowchart. The system starts the event-camera module and initializes the detection algorithms that run on the connected processing unit. The processor receives the event data from the camera, which camera scans the FOV area in a given direction to detect predefined anomalies that correspond to candidate aerial objects from event-pixels streamed from the camera that reacts to the change of light at the pixel level.

When a candidate object is detected within the field of view of the event-camera, a series of event data is generated and accumulated to an event data buffer. The processor uses multiple algorithms to analyze the series of event data to find the target's feature based on the target shape, frequency and trajectory.

The detected candidate object can be identified from its shape (using Dynamic Neural Net (DNN) architecture for object detection), and/or by analyzing the frequency of the object's movement. For example, the object's propellers' RPM may be matched against a dataset of known propellers' frequencies. The processor may determine the object trajectory and speed to classify, track the object and also in some cases calculate its trajectory and origin. For example, drones can be identified by matching its overall size, overall shape and the propeller frequency from the event-data change against a dataset of predefined classified objects.

In the case of a stereo-vision approach (using two or more events-cameras) or using a laser range finder or radar to detect the distance, the algorithms may take the object's distance into account and provide positioning of the detected flying object. This information can also be used to predict the impact of flight direction and, in some cases, object origin.

The processor can also estimate object distance with only one camera by comparing the captured event pixels with each known object's physical size. That is the number of event pixels within a FoV of known size leads to an inverse relationship between object size and distance away, such that a few pixels may indicate that a large object is far away or a small object is close. Similarly changes in captures image size can indicate motion towards or away from the camera. E.g. for a object captured with an image size 90% less than the known object size (i.e. X−90%), the processor can estimate the distance from the camera. As the captured object size increases to 30% less than the known object size (i.e. X−30%), the processor can determine that the object is getting closer to the camera and moving at a speed determined from the time delta for the change.

For example, when looking for mortars that have a well-known size (as well as speed, flying characteristics, and max range), the processor can calculate its origin or/and use a trained artificial neural network to estimate the mortar origin.

The processing system may input the detected physical properties of (object size, speed, spin, frequencies (rocket and propeller) to one or more of: a candidate object lookup table; fuzzy logic equation; Markov Decision Process; or Neural Net to output a prediction of the identity of the object or probability of each class of object.

Another algorithm may reconstruct the event-image into a normal visible monochrome image that can be used to run AI and/or Machine Vision algorithms to detect and classify the object type such as drone, drone type (multirotor or fixed-wing, etc.), missile. Such shape detection can also work without the reconstruction algorithm by using an event-based data with an AI classifier trained on event data. Such a system may use Yolo V4 as DNN detector. The DNN detector can be replaced or reorganized for the purpose of performance.

Another algorithm may use the movement of the object to analyze its movement in 3D space and time axes. Based on the object's speed, trajectory, and/or classification, the system can classify and estimate the object's origin, future positions or intended target, especially when dealing with predictable ballistic objects like mortars, missiles, or bullets.

The system reports the object detection and classification to the ground control station as detection information. The system's position/coordinates may be known from GPS and distance from the detected object can be determined by range detection systems (such as LIDAR or radar). These data are used in triangulation algorithms to provide the geographic coordinates of the object in real-time.

1. A method of detecting aerial objects comprising:
capturing event images of a scene using an event-based camera;
detecting event within the event-data; and
computing properties of the detected events to detect candidate aerial objects and compute their physical properties.

2. The method of claim 1, wherein the event images comprises pixel coordinates, timestamp, and polarity of change.

3. The method of claim 1, wherein the computed physical properties of candidate aerial objects is one or more of: speed, size, shape, propeller rotation, spin, and vibration frequency.

4. The method of claim 1, wherein the event-based camera is located on an unmanned aerial vehicle (UAV), manned vehicle, ground platform or sea platform.

5. The method of claim 1, further comprising computing a trajectory of the detected candidate objects from a plurality of detected events

6. The method of claim 5, further comprising extrapolating an estimated origin of the object from the computed trajectory.

7. The method of claim 5, further comprising extrapolating an estimated target or future location of the object from the computed trajectory.

8. The method of claim 1, further comprising identifying an aerial object classification of the candidate aerial object(s) from the computed properties of the detected events and/or candidate aerial objects.

9. The method of claim 1, further comprising setting the field of view for the event-based camera using a frame-based camera.

10. An aerial detection system comprising:
an event-based camera for capturing event images of a scene;
a processor for detecting events within the event-images and computing properties of the detected events to detect candidate aerial objects and compute their physical properties.

11. The aerial detection system of claim 10, further comprising an unmanned aerial vehicle (UAV) housing the event-based camera and processor.

12. The aerial detection system of claim 10, further comprising a frame-based camera to set the field of view for the event-based camera.

13. The aerial detection system of claim 10, further comprising means to pan, tilt, and zoom the event-based camera.

14. The aerial detection system of claim 10, further comprising at least one further event-based cameras arranged in a stereo, panoramic or spherical capture arrangement.

15. The aerial detection system of claim 10, further comprising ranging means to detect a distance of the detected object from the event-based camera.

16. The aerial detection system of claim 10, further comprising illumination means.
